(19) United States
(12) Patent Application Publication
(10) Pub. No.: US 2022/0124385 A1
(43) Pub. Date: Apr. 21, 2022

(54) SYSTEMS AND METHODS FOR GENERATING DIGITAL VIDEO CONTENT FROM NON-VIDEO CONTENT

(71) Applicant: Allstar Gaming, Inc., New York, NY (US)

(72) Inventors: Nicholas Cuomo, Brooklyn, NY (US); Gavin Silver, New York, NY (US)

(73) Assignee: Allstar Gaming, Inc., New York, NY (US)

(21) Appl. No.: 17/507,557

(22) Filed: Oct. 21, 2021

Related U.S. Application Data
(60) Provisional application No. 63/094,816, filed on Oct. 21, 2020.

(51) Int. Cl. H04N 21/2343; G06K 9/00; H04N 21/234; H04N 21/258; H04N 21/643; G06T 1/20; H04N 21/83; A63F 13/52

(52) U.S. Cl. CPC H04N 21/2343; G06K 9/00523; H04N 21/23418; H04N 21/23412; G06K 2209/27; H04N 21/643; G06T 1/20; H04N 21/83; A63F 13/52; H04N 21/25891

(57) ABSTRACT

Embodiments of the present invention provide for generating digital video content from non-video content. The systems and methods provide for, upon receiving an input from an end user to generate the digital video content, retrieving the non-video content; extracting metadata from the non-video content; combining the non-video content, the extracted metadata, and user preferences into a digital content instruction package; and generating the digital video content based on the digital content instructions package, wherein the creating of the digital video content includes (i) modifying the digital video content based on the user preferences and (ii) displaying the modified digital video content to the end user.

### CROSS-REFERENCE TO RELATED APPLICATION

This application claims the benefit of U.S. Provisional Patent Application No. 63/094,816, which was filed on Oct. 21, 2020 and is incorporated by reference in its entirety.

### FIELD OF THE INVENTION

The present disclosure relates to systems and methods for generating digital video content from non-video content.

### BACKGROUND OF THE INVENTION

Currently, if an end user wants to capture digital video content from a digital environment, e.g., a digital gaming environment, the end user would have to use a screen recorder. However, current screen recorder technology negatively impacts live digital gameplay by degrading the framerate of the digital gameplay video content. Further, screen recording is also limited in that only two-dimensional video content and audio content of the digital gameplay video content is recorded. In other words, the recorded digital gameplay video content is a flattened version of the digital gameplay video content. As such, the end user is not able to manipulate the recorded digital gameplay video content as they would the actual digital gameplay video content.

As such, it would be desirable to have systems and methods that could overcome these and other deficiencies of known systems.

### SUMMARY OF THE INVENTION

Embodiments of the present invention relate to system and methods for generating digital video content from non-video content.

According to an embodiment, a method for generating digital video content from non-video content can include: (a) upon receiving an input from an end user to capture the digital video content, retrieving data associated with the digital video content; (b) extracting metadata associated with the retrieved data associated with the digital video content (c) combining the non-video content, the extracted metadata, and user preferences into a digital content instruction package; and (d) creating a digital video file based on the digital content instructions package, wherein the creating of the digital video file includes (i) modifying the digital video content based on the user preferences and (ii) displaying the modified digital video content to the end user.

According to an embodiment, a system for generating digital video content from non-video content can include one or more processing devices, wherein the one or more processing devices are configured to: (a) upon receiving an input from an end user to generate the digital video content, retrieve the non-video content; (b) extract metadata from the non-video content; (c) combine the non-video content, the extracted metadata, and user preferences into a digital content instruction package; and (d) generate the digital video content based on the digital content instructions package, wherein the generating of the digital video content includes (i) modifying the digital video content based on the user preferences and (ii) displaying the modified digital video content to the end user.

In this regard, embodiments of the invention can enable end users to generate digital video content from non-video content using one or more cloud-enabled processing devices, without dependence on the end user's local hardware ensuring an un-disrupted digital video experience.

These and other advantages will be described more fully in the following detailed description.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of embodiments of the disclosure. In this regard, the description, taken with the drawings, makes apparent to those skilled in the art how aspects of the disclosure may be practiced.

FIG. 1 depicts an exemplary system for generating digital video content from non-video content according to exemplary embodiment of the invention.

FIG. 2 depicts an exemplary processing device used in the system of FIG. 1 according to an exemplary embodiment of the invention.

### DETAILED DESCRIPTION

This description is not intended to be a detailed catalog of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to affect a disavowal of any part of the full scope of the invention. Hence, the following descriptions are intended to illustrate some particular embodiments of the disclosure, and not to exhaustively specify all permutations, combinations and variations thereof.

Unless explicitly stated otherwise, the definition of any term herein is solely for identification and the reader's convenience; no such definition shall be taken to mean that any term is being given any meaning other than that commonly understood by one of ordinary skill in the art to which this disclosure belongs, unless the definition herein cannot reasonably be reconciled with that meaning. Further, in the absence of such explicit definition, all technical and scientific terms used herein have the same meaning as commonly understood by one of ordinary skill in the art to which this disclosure belongs. The terminology used in the description of the disclosure herein is for the purpose of describing particular embodiments only and is not intended to be limiting of the disclosure.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

As used in the description of the disclosure and the appended claims, the singular forms “a”, “an”, and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

According to an embodiment, an exemplary system can include a representational state transfer application programming interface (RESTful API) for connecting and accessing non-video content. For example, the RESTful API can be integrated into a desktop device, mobile device, or other device including a processing device. In this regard, the non-video content can be a demo/replay file, e.g., .DEM format file, .REPLAY format file, .REC format file, .ROFL format file, .HSREPLAY format file, .StormReplay format file, .REP format file, .LRF format file, .OSR format file, .YDR format file, .SC2REPLAY format file, .WOTREPLAY format file, .WOWSREPLAY format file, .W3G format file, .ARP format file, .MGL format file, .RPL format file, .WOTBREPLAY format file, .MGX format file, .KWREPLAY format file, .PEGN format file, .QWD format file, .DM2 format file, .DMO format file, etc. According to an embodiment, the non-video content can be used for the creation of enriched digital video content, analyzing the underlying activity in the digital video content, and extracting rich metadata around the actions, activities, and behaviors that took place in the digital environment. In this regard, assuming the digital environment is a gaming environment, examples of rich metadata can include player data (e.g., health, ammo, position, inventory, weapons, actions, emotes, chat, sentiment), gameplay data (e.g., context, situation, game time, round, game type, server side configuration settings, client side configuration settings, map played), personalization data (e.g., in-game virtual cosmetic items equipped, rank, achievements, player avatar configurable options, user generated content displayed in game, local player configuration data), match data (e.g., players in match, player IDs, player scores, kills, deaths, assists, team kills, points, match level achievements), as well as any other data that the game is reading, accessing and transmitting or displaying to the end user/game client, that is also recorded, saved, stored and replayable via the replay or demo file. According to another embodiment, the digital environment can be one of a virtual reality (VR) digital environment or an augmented reality (AR) digital environment.

According to another embodiment, the non-video content can be accessed via a software application on a desktop device, mobile device, other device including a processing device.

According to an embodiment, the generation of the digital video content can be initiated by an end user. In this regard, where text chat is available, the end users can initiate the generation of enriched digital video content by typing an input chat command into the game's text chat, for example: “!allstar.” According to an embodiment, the exemplary system can detect the presence of the input command through a variety of means depending on the digital environment, e.g., data parsing, log tailing, optical character recognition, keystroke identification, API integration, etc. According to an embodiment, the exemplary system can then attribute the command back to the end user, verify the end user, and create a “clip event” in system's backend, which tells the exemplary system to begin the process of extracting the necessary data in order to create the enriched digital video content.

According to an embodiment, the necessary extracted data can include local user time event data (e.g., when the end user initiated the input to signify the intent to create content), server side event data (e.g., the server-reported time at the moment the event was recorded), and in-game data such as events recorded, observed or occurring during the time of the event, for matching or recognition at playback time of the demo file in order to match and identify the intended moment the player wanted to create content. According to an embodiment, data is extracted from log files produced by the game. In this regard, the extracted game data can be created in real time using a controlled software application running in parallel to the game being played. Further, data can also be extracted server-side from the game server itself, or the services the game server runs on. Data can also be extracted from the in-game memory, the on-screen display, or any other system or storage attached to the device the end user is using to play the game.

According to another embodiment, users can also initiate the generating process using a hotkey on a keyboard (e.g., F8), other in-game tie-ins, such as character emotes, or external devices such as via voice assistants.

According to an embodiment, once the non-video content is received (e.g., by activation by the end user via the API integration), it is then parsed and analyzed. In this regard, assuming the digital environment is a gaming environment, the data can be received by various methods depending on the input logic for the game, match type, and the circumstance of the event (e.g., intent to record a portion of digital gameplay video content). In cases where a local demo file is created, the demo file is transferred to an exemplary platform. According to another embodiment, if the demo file is received from a third-party platform, it can be downloaded to the exemplary platform directly from the third-party's platform game server hosting that file. According to an embodiment, the parsing is a process that converts in-game events to specific usable information and timeline information. For example, a match in a game can be parsed, e.g., by parsing the demo/replay file, to show all eliminations by all end users and, after analyzing the timeline, it can be determined that only information for a specific player is needed (which is then stored by the exemplary platform). In this regard, the demo/replay file can be parsed based on relevant data developed around the behaviors of the particular end user and other end users For example, the demo/replay file can be parsed in order to focus on data associated with a particular end user, Epoch time, and/or event, e.g., “Player A eliminates Player B at time code 4:05.” This information can then be used to instruct the exemplary platform to start generating the digital video content 30 seconds before 4:05 from the perspective of Player A. According to an embodiment, the data subsets of the demo/replay file can be parsed and analyzed in a serialized manner.

According to an embodiment, after the data is parsed, exemplary data files and instructions are created for other services within the exemplary platform to facilitate: (i) the playback and creation of the digital gameplay video content, (ii) customization and enhancement of content at the time of game playback; (iii) video capture; and (iv) post-processing automation of visual effects, music, sound, timing changes, visual effects, content overlays, etc. In this regard, the exemplary data files and instructions can be implemented as demo and instruction files. According to an embodiment, the demo file is a binary file representing the entire game match the user participated in. Further, the instruction file is a custom language file with time-coded commands to manipulate the in-game recording process (e.g., camera, angle, settings, etc.).

Further, depending on the data received by the exemplary platform, additional services can be activated by the exemplary platform, e.g., initiating specific game servers to play back specific types of demo or replay files for different games, initiating specific post-processing and video editing automation services depending upon the instructions (or other input that can determine what the final content is intended to be).

According to an embodiment, the exemplary platform provides the end user the ability to perform in-game jumps in time (e.g., forwards and backwards), in-game camera changes, physical timing changes, and head-up display (HUD) customizations. In this regard, each of the above can be performed based on the instructions received from the data parsing. According to an embodiment, the instructions can include a mix of per-game preferences, user preferences, and per-clip preferences, which allows for the in-game content to be modified in real time before video content is captured during playback. According to an embodiment, instructions can be provided to the exemplary platform at the time of playback of the digital gameplay video content. In particular, instructions can be passed to either the game itself via key presses, or programmatic interfaces, or to application layers that run in parallel to the game, manipulating the game itself in order to achieve the desired in-game effects. Instructions can also be provided prior to playback to the exemplary platform (or software application) that can prepare the digital gameplay video environment in accordance with the desired settings, personalization, and configurations to achieve the intended content playback.

According to an embodiment, after the digital gameplay video content is created, it can then be provided to the exemplary platform's post-processing automation module. In this regard, key frames of the digital gameplay video content are established correlating points of in-game points of interest an events with an editing timeline, allowing for automation of editing to cut footage from the digital gameplay video content, speed up or slow down the timing of the digital gameplay video content, apply pre-built effects, layer in music and sound, apply color treatments, add in graphics or video files, and apply enhancements and operative instructions. According to an embodiment, rich data can be correlated with time-based data and then organized in sequence as a metadata layer which exists in parallel to the content. This metadata layer can then be accessed programmatically in order to be assessed against pre-determined decision making logic that is provided to the exemplary platform prior to the start of the automated editing process. The automated editing process can then create an instruction set based upon the decision-making logic being applied against the available rich data set. This instruction set can then activate a set of cloud services, software packages and/or various tools chained together, which are automatically orchestrated based upon the resulting instruction set. The exemplary platform then carries the content through each tool in the chain until all instructions are complete, at which time the content is finalized and provided to another service for distribution and enrichment.

According to an embodiment, the parsed data is then analyzed by the exemplary platform in order to convert the data into accessible information for use in content discovery and organization, content titling and descriptions, and the creation of social media optimized preview thumbnails compatible with the Open Graph Protocol. In this regard, the data is run through a plurality of exemplary algorithms and logic trees in order to assign organizational tags, apply linguistically appropriate titles, and generate image based thumbnails that incorporate the resulting tags and titles to make visual decisions that result in an intended personalized thumbnail. According to an embodiment, the title can also be included as Open Graph Protocol metadata.

According to an embodiment, a finalized clip can then be distributed to a web platform, e.g., Internet-based software platform, as well as among different social media channels, e.g., Discord, Facebook, Twitter, YouTube, Twitch, Vimeo, TikTok, Instagram and Snapchat. In this regard, the end user can set their preferences for the desired distribution channels before the clips are created. As such, after the clips are created, they can be automatically distributed to the desired channels. According to an embodiment, the web platform is distinct from the exemplary platform that generates the clip of the digital video gameplay content. In this regard, the web platform can include a cloud computing technology based graphics processing unit (GPU) (or any other cloud computing technology based processing unit that is capable of automated playback of intensive digital video applications, e.g., three-dimensional (3D) video content, VR video content, AR video content, etc.

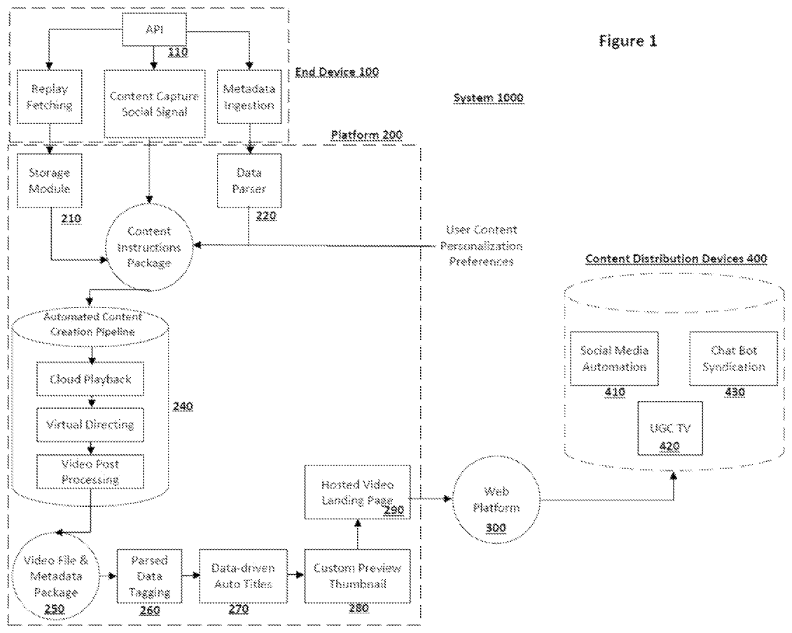

FIG. 1 depicts an exemplary system for generating digital video content from non-video content according to exemplary embodiment of the invention. As depicted in the figure, an exemplary system 1000 can include an end device 100, a platform 200, a web platform 300, and content distribution devices 400.

According to an embodiment, the end device 100 can include a RESTful API 110. Further, the platform can include at least one of a storage module 210, a data parser 220, an automated content creation pipeline 240. Further, the content distribution devices 400 include social media automation 410, user-generated content (UGC) TV 420, and chat bot syndication 430.

According to an embodiment, the RESTful API 110 can retrieve particular non-video content (e.g., demo/replay files, etc.) from a digital video gaming environment. In particular, the RESTful API 110 can retrieve the particular non-video content after receiving an input from an end user indicating a desire to generate the digital video content. In this regard, the RESTful API 110 is configured to: (i) capture the game replay/demo files, (ii) indicate to the exemplary platform 200 when digital video content should be generated, and (iii) extract metadata from the non-video content.

Then, as depicted in the figure, the replay file is provided to the storage module 210 and the extracted metadata is provided to the metadata parser 220. Then, this information, along with user content personalization preferences, is combined into a digital record, e.g., content instructions package. According to an embodiment, the non-video content, extracted metadata, and the user content personalization preferences can be combined around end user data, time data, and event data. The content instructions are then provided to the automated content creation pipeline 240, which can playback the game data with the cloud playback functionality of the pipeline 240. In this regard, if there are any user settings or preferences included in the instructions, e.g., that indicate in-game camera moves or changes to the gameplay itself, the virtual director functionality of the pipeline 240 is configured to manipulate the data content in real time during playback. Then, once a final video file is created, it can be provided to a video post-processing module in order to apply any desired post-processing changes to the created video file, e.g., lighting, color, edits, time manipulation, overlays, filter, music, sound, etc.). Then, the parsed metadata can be combined with the resultant video file into a data package 250. The data package 250 then goes through an exemplary distribution process, which includes taking the metadata and converting it into web-friendly tags (e.g., parsed data tagging 260) and then automatically generating a title based on said tags (e.g., data-driven auto tiles 270). Then, a flat 2D image thumbnail is generated using a screenshot of the final video file, with the automatically-generated title (e.g., custom preview thumbnail 280). Then, a web page (e.g., hosted video landing page 290) is generated on the exemplary platform in order to host the final video file, the tags, the automatically-generated title, and the thumbnail in order to share the final video file among different social media channels, e.g., Discord, Facebook, Twitter, YouTube, Twitch, Vimeo, TikTok, Instagram and Snapchat. The web page 290 can then be provided to the web platform 300 for searching, sorting, filtering. After which, the final video file can be posted from the web platform 300 to one of the different social media channels discussed above, e.g., Discord, Facebook, Twitter, YouTube, Twitch, and Vimeo (e.g., social media automation 410). Further, the final video file can also be incorporated into any other syndicated entertainment that is created from user-generated content (e.g., UGC TV 420). Lastly, the final video file can also be distributed to any chat bot service (e.g., chat bot syndication 430).

According to an embodiment, the final video file can be a different resolution than the one that was used in the originating device. Further, the final video file can be stored and distributed in multiple different formats and aspect ratios simultaneously (e.g., widescreen 16:9, square 1:1, vertical 4:5 and 9:16, and other common TV, desktop, or mobile formats). As such, in an exemplary embodiment, an end user can play a game at 1920×1080 on their PC but the exemplary platform can then render that same gameplay out as 1080×1920, so that it can be compliant with a mobile phone's resolution and, therefore, can look pleasing to the end user when the phone is being held vertically.

According to an embodiment, each of the end device 100, the platform 200, the web platform 300, and the content distribution devices 400 can be implemented on one or more processing devices (e.g., processing device 500) which can interact with each other via a communications network.

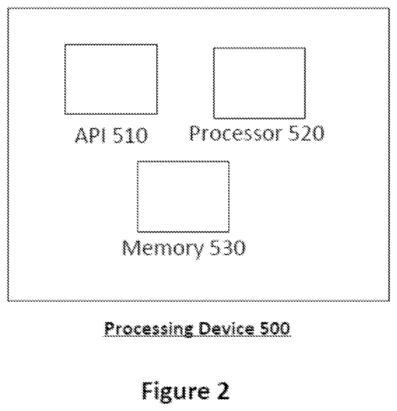

According to an embodiment, as depicted in the FIG. 2, each processing device 500 include a respective RESTful API 510, processor 520, and memory 530. According to an embodiment, the memory 530 can be used to store computer instructions and data including any and all forms of non-volatile memory, including semiconductor devices (e.g., SRAM, DRAM, EPROM, EEPROM, and flash memory devices), magnetic disks (e.g., internal hard disks or removable disks), magneto-optical disks, and CD-ROM and DVD-ROM disks. Further, the processor 520 can be suitable for the execution of a computer program, e.g., part or all of the processes described above, and can include both general and special purpose microprocessors, as well as any one or more processors of any kind of digital computer. Further, the processor 520 can receive instructions and data from the memory 530, e.g., to carry out at least part or all of the above processes. Further, the API 510 can be used to transmit relevant data to and from the end device 100, the platform 200, the web platform 300, and the content distribution devices 400. According to an embodiment, the processing device 500 in each of the end device 100, the platform 200, the web platform 300, and the content distribution devices 400 can be implemented with cloud-computing technology-enabled services, e.g., infrastructure-as-a-service (IaaS), Platforms-as-a-Service (PaaS), and Software-as-a-Service. According to another embodiment, the processing devices 500 can be implemented in a high availability and/or modular cloud architecture

According to an embodiment, the communications network can include, or can interface to, at least one of the Internet, an intranet, a local area network (LAN), a wide area network (WAN), a metropolitan area network (MAN), a storage area network (SAN), a frame relay connection, an advanced intelligent network (AIN) connection, a synchronous optical network (SONET) connection, a digital T1, T3, E1 or E3 line, a digital data service (DDS) connection, a digital subscriber line (DSL) connection, an Ethernet connection, an integrated services digital network (ISDN) line, a dial-up port such as a V.90, a V.34 or a V.34bis analog modem connection, a cable modem, an asynchronous transfer mode (ATM) connection, a fiber distributed data interface (FDDI) connection, a copper distributed data interface (CDDI) connection, or an optical/DWDM network. In another embodiment, the communications network 315 can include, or can interface to, at least one of wireless application protocol (WAP) link, a Wi-Fi link, a microwave link, a general packet radio service (GPRS) link, a global system for mobile Communication (GSM) link, a Code Division Multiple Access (CDMA) link or a time division multiple access (TDMA) link such as a cellular phone channel, a GPS link, a cellular digital packet data (CDPD) link, a Research in Motion, Limited (RIM) duplex paging type device, a Bluetooth radio link, or an IEEE 802.11-based radio frequency link. Further, in another embodiment, the communications network 315 can include, or can interface to, at least one of an RS-232 serial connection, an IEEE-1394 (FireWire) connection, a Fibre Channel connection, an infrared (IrDA) port, a small computer systems interface (SCSI) connection, a universal serial bus (USB) connection or another wired or wireless, digital or analog interface or connection.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A method for generating digital video content from non-video content, the method comprising:
upon receiving an input from an end user to generate the digital video content, retrieving the non-video content;
extracting metadata from the non-video content;
combining the non-video content, the extracted metadata, and user preferences into a digital content instruction package; and
generating the digital video content based on the digital content instructions package, wherein the creating of the digital video content includes (i) modifying the digital video content based on the user preferences and (ii) displaying the modified digital video content to the end user.

2. The method of claim 1, wherein the input can be one of a text command or a voice command.

3. The method of claim 2, wherein the text command can be detected by at least one of data parsing, log tailing, optical character recognition, and keystroke identification.

4. The method of claim 1, wherein the non-video content is at least one of a .DEM format file, .REPLAY format file, .REC format file, .ROFL format file, .HSREPLAY format file, .StormReplay format file, REP format file, .LRF format file, .OSR format file, .YDR format file, .SC2REPLAY format file, .WOTREPLAY format file, .WOWSREPLAY format file, .W3G format file, .ARP format file, .MGL format file, .RPL format file, .WOTBREPLAY format file, .MGX format file, .KWREPLAY format file, .PEGN format file, .QWD format file, .DM2 format file, and .DMO format file.

5. The method of claim 1, wherein the non-video content is associated with a digital gaming environment.

6. The method of claim 5, wherein the extracted metadata is at least one of player data, gameplay data, personalization data, and match data.

7. The method of claim 1, further comprising:
generating a title and at least one organizational tag for the generated digital video content based on the extracted metadata; and
generating a digital two-dimensional (2D) image thumbnail based on the generated title and the at least one organizational tag.

8. The method of claim 7, wherein the 2D image thumbnail is compliant with Open Graph Protocol.

9. The method of claim 8, further comprising:
distributing the generated digital video content, along with the generated title, at least one organizational tag, and the 2D image thumbnail, to an Internet-based software platform.

10. The method of claim 9, wherein the Internet-based software platform includes a cloud computing technology based graphics processing unit (GPU).

11. A system for generating digital video content from non-video content, the system comprising:
one or more processing devices, wherein the one or more processing devices are configured to:
upon receiving an input from an end user to generate the digital video content, retrieve the non-video content;
extract metadata from the non-video content;
combine the non-video content, the extracted metadata, and user preferences into a digital content instruction package; and
generate the digital video content based on the digital content instructions package, wherein the generating of the digital video content includes (i) modifying the digital video content based on the user preferences and (ii) displaying the modified digital video content to the end user.

12. The system of claim 11, wherein the input can be one of a text command or a voice command.

13. The system of claim 12, wherein the text command can be detected by at least one of data parsing, log tailing, optical character recognition, and keystroke identification.

14. The system of claim 11, wherein the data associated with digital video content is at least one of a .DEM format file, .REPLAY format file, .REC format file, .ROFL format file, .HSREPLAY format file, .StormReplay format file, REP format file, .LRF format file, .OSR format file, .YDR format file, .SC2REPLAY format file, .WOTREPLAY format file, .WOWSREPLAY format file, .W3G format file, .ARP format file, .MGL format file, .RPL format file, .WOTBREPLAY format file, .MGX format file, .KWREPLAY format file, .PEGN format file, .QWD format file, .DM2 format file, and .DMO format file.

15. The system of claim 11, wherein the non-video content is associated with a digital gaming environment.

16. The system of claim 15, wherein the extracted metadata is at least one of player data, gameplay data, personalization data, and match data.

17. The system of claim 11, wherein the one or more processing devices are further configured to:
generating a title and at least one organizational tag for the generated digital video content based on the extracted metadata; and
generating a digital two-dimensional (2D) image thumbnail based on the generated title and the at least one organizational tag.

18. The system of claim 17, wherein the 2D image thumbnail is compliant with Open Graph Protocol.

19. The system of claim 18, wherein the one or more processing devices are further configured to:
distributing the generated digital video content, along with the generated title, at least one organizational tag, and the 2D image thumbnail, to an Internet-based software platform.

20. The system of claim 19, wherein the Internet-based software platform includes a cloud computing technology based graphics processing unit (GPU).
